(19) United States
(12) Patent Application Publication
(10) Pub. No.: US 2005/0086398 A1
(43) Pub. Date: Apr. 21, 2005

(54) Method of changing EDID of motherboard

(75) Inventor: Yung-Shun Chuang, Hsin-Tien City (TW)

Correspondence Address: RABIN & BERDO, P.C., Suite 500, 1101 14 Street, N.W., Washington, DC, 20005, US

(73) Assignee: AAEON TECHNOLOGY INC., Hsin-Tien City (TW)

(21) Appl. No.: 10/687,840

(22) Filed: Oct. 20, 2003

(51) Int. Cl. G06F 13/10

(52) U.S. Cl. 710/16

(57) ABSTRACT

A method of changing EDID of a memory of a motherboard in response to replacing an LCD panel of a computer with a different one comprises detecting a chipset; reading a SM bus base or GPIO base; activating a writing mechanism; selecting compatible EDID; writing the EDID into the memory; detecting an error; and closing the writing mechanism. The invention can be embodied by means of software rather than hardware. Thus, it is much convenient.

### BACKGROUND OF THE INVENTION

1. Field of the Invention

The present invention relates to method of changing settings of a motherboard and more particularly to a method of changing an EDID (extended display identification data) stored in memory of a motherboard by means of software rather than hardware in response to replacing an LCD (liquid crystal display) panel of a computer with a different one.

2. Description of Related Art

Conventionally, an LCD panel of computer has a unique EDID which is defined by VESA (Video Electronic Standards Association) standard. Electrical characteristics of an LCD panel are stored in EDID. EDID is a protocol of DDC (display data channel) for enabling a computer to correctly identify specifications of the LCD panel for control. EDID is typically stored in an EEPROM (electrically erasable programmable read-only memory) of a motherboard. This means that EDID is unique to each motherboard. Thus, the motherboard and thus the computer may not function normally if the original LCD panel is replaced by a new one of different brand. For solving this problem, the only method is to remove the EEPROM from the motherboard prior to burning in a compatible EDID into the EEPROM. Further, it is required to remove the EEPROM from the motherboard prior to burning in changed parameters of EDID into the EEPROM if parameters of LCD panel are required to change. In view of the above, it is not convenient. Hence, a need for improvement exists.

### SUMMARY OF THE INVENTION

It is an object of the present invention to provide a method of changing EDID of a memory of a motherboard in response to replacing an LCD panel of a computer with a different one, comprising the steps of detecting a chipset; reading a SM bus base or GPIO (General Purpose Input Output) base; activating a writing mechanism; selecting compatible EDID; writing the EDID into the memory; detecting error; and closing the writing mechanism.

The above and other objects, features and advantages of the present invention will become apparent from the following detailed description taken with the accompanying drawings.

### BRIEF DESCRIPTION OF THE DRAWINGS

FIG. 1 is a block diagram of the invention;

FIG. 2 is a flow chart showing a sequence of method steps performed by the invention;

FIG. 3 illustrates a screen that is shown to a user in performing the invention; and

FIG. 4 illustrates another screen for changing files.

### DETAILED DESCRIPTION OF THE PREFERRED EMBODIMENTS

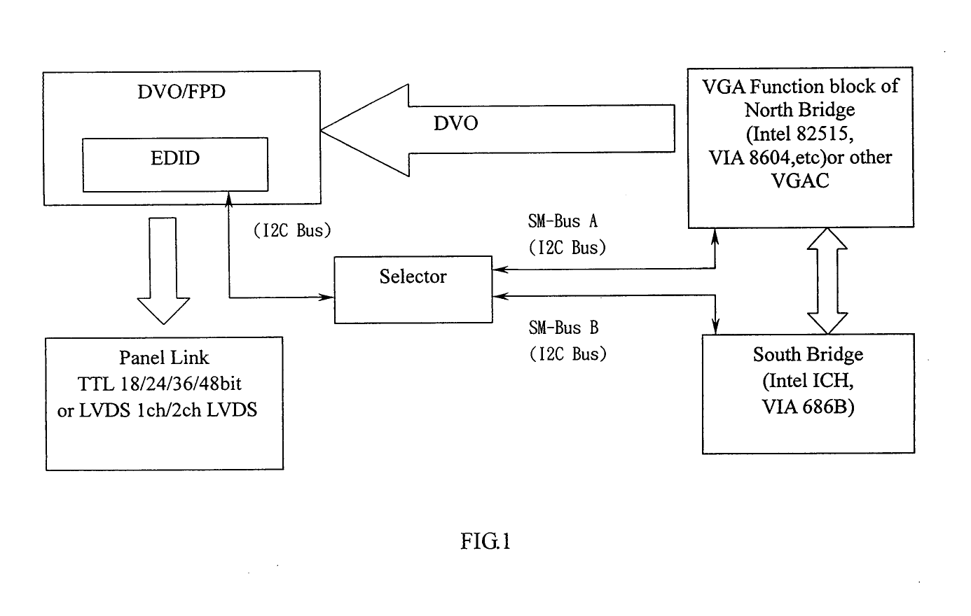

Referring to FIG. 1, a LCD VGA (Video Graphics Array) controller of the invention accesses EDID of a desired LCD via a SM (system management) bus (or I2C bus) of DVOI (Digital Video Output Interface) and a selector. As such, initialization data for illuminating LCD panel can be obtained. Hence, different LCD panels can be controlled by changing EDID with respect to factors such as brightness adjustment, etc.

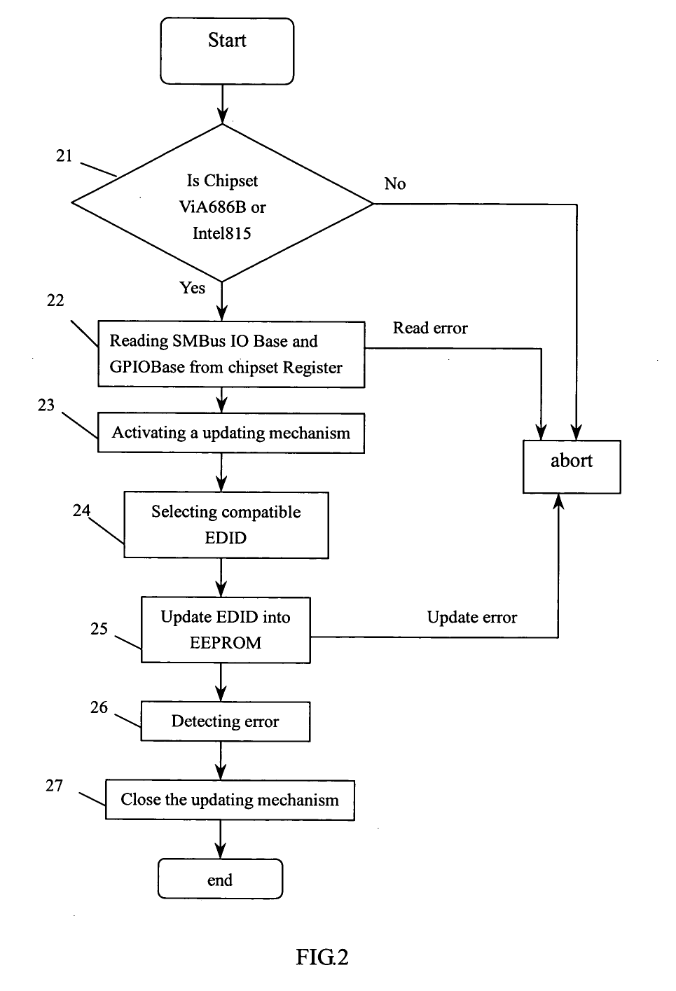

Referring to FIG. 2, there is shown a process of the invention. The process comprises the steps of detecting a chipset for determining whether it is VIA 686B or Intel 815 (step 21); reading SM bus base or GPIO (General Purpose Input Output) base (step 22) if the determination step is positive else ending the process; activating a writing mechanism if the reading is correct (step 23); selecting compatible EDID (step 24); writing EDID into EEPROM (step 25); detecting error (step 26) if the writing is correct; and closing the writing mechanism (step 27) prior to ending the process.

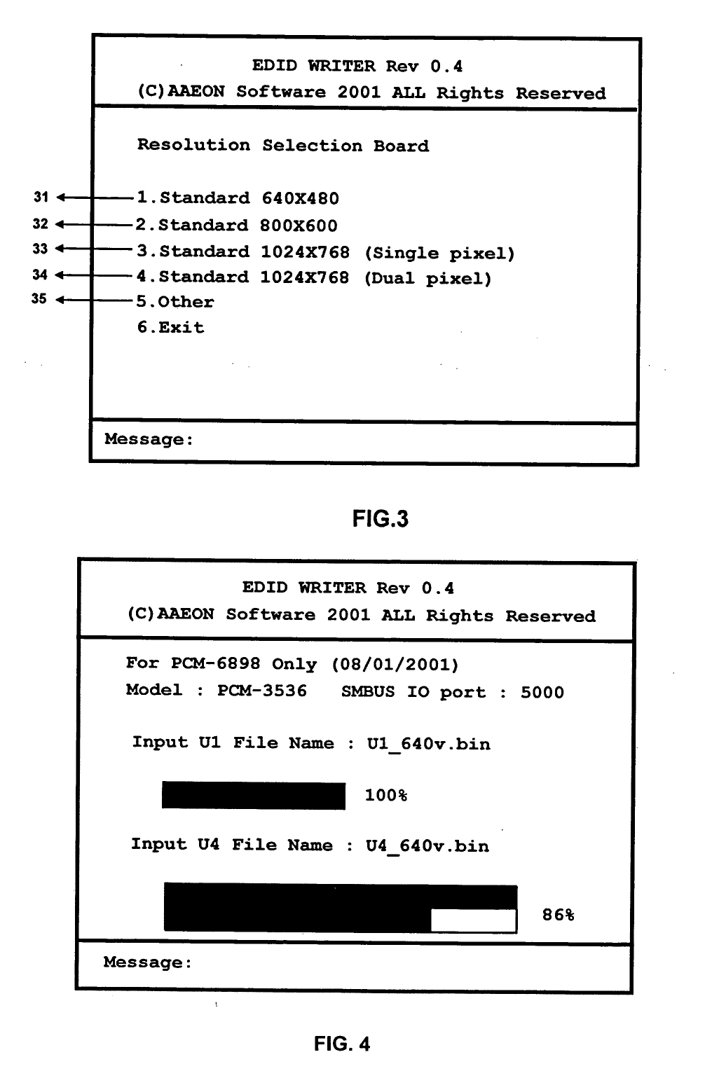

Referring to FIG. 3, there is shown a screen of the invention. As shown, a predetermined number of ID files are available to select on the screen. The ID files comprise standard 640*480 pixels (31), standard 800*600 pixels (32), standard 1024*768 single and dual pixels (33 and 34), and others for selecting a bin file (35). The process of the invention will store EDID in memory (e.g., EEPROM) if the selected EDID is compatible with that of the LCD panel. Referring to FIG. 4, stored filenames and associated information are shown on the screen. EDID comprises a number of parameters adapted to change. For example, a maximum horizontal image size is defined in address 15h, and Gamma value to be transmitted is defined in address 17h. These parameters are recorded in a bin file. Changes of the parameters can be carried out by editing the bin file and clicking the others (35) option of the above screen to write the changed EDID.

In brief, the invention can carry out a method of changing an EDID stored in memory of a motherboard by means of software rather than hardware if the original LCD panel is replaced by a new one of different brand. As an end, a plug and display feature can be obtained.

While the invention herein disclosed has been described by means of specific embodiments, numerous modifications and variations could be made thereto by those skilled in the art without departing from the scope and spirit of the invention set forth in the claims.

1. A method of changing EDID of a memory of a motherboard in response to replacing an LCD panel of a computer with a different one, comprising the steps of:
detecting a chipset;
reading a SM bus base or GPIO (General Purpose Input Output) base;
activating a writing mechanism;
selecting compatible EDID;
writing the EDID into the memory;
detecting an error; and
closing the writing mechanism.

2. The method of claim 1, wherein the EDID comprises a plurality of parameters adapted to change.

3. The method of claim 1, wherein the detection step comprises the sub-step of determining whether the chipset is a VIA 686B or Intel 815.
